(19) United States
(12) Patent Application Publication
(10) Pub. No.: US 2016/0050473 A1
(43) Pub. Date: Feb. 18, 2016

(54) ELECTRONIC DEVICE

(71) Applicant: Samsung Electronics Co., Ltd., Suwon-si (KR)

(72) Inventor: Woo-Chul LEE, Suwon-si (KR)

(21) Appl. No.: 14/828,858

(22) Filed: Aug. 18, 2015

(30) Foreign Application Priority Data
Aug. 18, 2014 (KR) 10-2014-0106849

(51) Int. Cl. H04R 1/04

(52) U.S. Cl. CPC H04R 1/04

(57) ABSTRACT

An electronic device is provided. The electronic device includes a circuit board having a sound input hole penetrating through both surfaces of the circuit board, a microphone mounted on the circuit board, the microphone configured to receive a sound through the sound input hole, a first grounding pad surrounding the sound input hole on a surface of the circuit board, and a second grounding pad surrounding the first grounding pad on the surface of the circuit board. The microphone is mounted on the circuit board by soldering the microphone to the first and second grounding pads.

### CROSS-REFERENCE TO RELATED APPLICATION(S)

This application claims the benefit under 35 U.S.C. §119(a) of a Korean patent application filed on Aug. 18, 2014 in the Korean Intellectual Property Office and assigned Serial number 10-2014-0106849, the entire disclosure of which is hereby incorporated by reference.

### TECHNICAL FIELD

The present disclosure relates to an electronic device. More particularly, the present disclosure relates to an electronic device having a microphone.

### BACKGROUND

An electronic device may include an input/output (I/O) device such as a camera module for acquiring image information, a microphone for inputting a sound, various types of keypads, a display for outputting a screen, and a speaker for outputting a sound. As an electronic device such as a portable terminal (e.g., a portable phone, an electronic note, a portable multimedia player, and the like) becomes small and lightweight, the integration level of circuits including an I/O device increases. Despite the trend toward small sizes and lightweight of electronic devices, continuous efforts have been made to increase the quality (e.g., video quality and sound quality) of an output device such as a display or a speaker. For example, the sound quality of the speaker may be increased by securing a resonant space around a speaker module that outputs a sound.

Due to the trend toward small sizes and lightweight of electronic devices, securing an additional resonant space in the speaker is difficult. Moreover, securing an additional resonant space in a wearable electronic device such as a wrist-type electronic device that has recently been commercialized is difficult. Accordingly, the space inside a small, lightweight electronic device is used as a resonant space to improve sound quality.

However, if the inner space of a small electronic device is used as a resonant space, a sound output from a speaker may be introduced into a microphone. Although the microphone may be isolated from the other space inside the electronic device by installing an additional shielding structure to prevent this phenomenon, securing even a space in which the shielding structure can be installed in the small electronic device such as a wearable one is difficult. Even though a sufficient space is secured inside the electronic device, installation of the additional shielding structure may decrease design freedom in a layout of electronic parts.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an electronic device for preventing introduction of a sound output from a speaker into a microphone without installing an additional shielding structure.

Another aspect of the present disclosure is to provide an electronic device of which the inner space can be used efficiently, while suppressing interference between a speaker and a microphone.

In accordance with an aspect of the present disclosure, an electronic device is provided. The electronic device includes a circuit board having a sound input hole penetrating through both surfaces of the circuit board, a microphone mounted on the circuit board, the microphone configured to receive a sound through the sound input hole, a first grounding pad surrounding the sound input hole on a surface of the circuit board, and a second grounding pad surrounding the first grounding pad on the surface of the circuit board. The microphone is mounted on the circuit board by soldering the microphone to the first and second grounding pads.

In accordance with an aspect of the present disclosure, an electronic device is provided. The electronic device includes a circuit board having a sound input hole penetrating through the circuit board, a microphone mounted on the circuit board, a first grounding pad surrounding the sound input hole on a surface of the circuit board, and a second grounding pad surrounding the first grounding pad on the surface of the circuit board.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a network environment including an electronic device according to various embodiments of the present disclosure;

FIG. 2 is a perspective view of an electronic device according to various embodiments of the present disclosure;

FIG. 3 is a side view of an electronic device according to various embodiments of the present disclosure;

FIG. 4 is a first sectional view of a body of an electronic device according to various embodiments of the present disclosure;

FIG. 5 is a plan view of an enlarged part of a circuit board in an electronic device according to various embodiments of the present disclosure; and

FIG. 6 is a second sectional view of a body in an electronic device according to various embodiments of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Although ordinal numbers such as ‘first’, ‘second’, and so forth will be used to describe various components, those components are not limited by the terms. The terms are used only for distinguishing one component from another component. For example, a first component may be referred to as a second component and likewise, a second component may also be referred to as a first component, without departing from the teaching of the concept of the present disclosure. The term ‘and/or’ used herein includes any and all combinations of one or more of the associated listed items.

In addition, relative terms used to describe what is shown in the drawings, such as ‘front surface’, ‘rear surface’, ‘top surface’, and ‘bottom surface’ may be replaced with ordinal numbers such as ‘first’, ‘second’, and the like. The ordinal numbers such as ‘first’, ‘second’, and the like are enumerated in a mentioned or arbitrary order and thus the order of the ordinal numbers may be changed arbitrarily when needed.

The terminology used herein is for the purpose of describing an embodiment only and is not intended to limit the present disclosure. It will be further understood that the terms ‘comprises’ and/or ‘has’ when used in this specification, specify the presence of stated feature, number, step, operation, component, element, or a combination thereof but do not preclude the presence or addition of one or more other features, numbers, steps, operations, components, elements, or combinations thereof.

The terms used herein, including technical and scientific terms, have the same meanings as terms that are generally understood by those skilled in the art, as long as the terms are differently defined. It should be understood that terms defined in a generally-used dictionary have meanings coinciding with those of terms in the related technology. As long as the terms are not defined obviously, the terms are not ideally or excessively analyzed as formal meanings.

An electronic device according to the present disclosure may be any device equipped with a touch panel. An electronic device may be referred to as a terminal, a portable terminal, a mobile terminal, a communication terminal, a portable communication terminal, a portable mobile terminal, a display device, and the like.

For example, the electronic device may be any of a smart phone, a portable phone, a navigation device, a game console, a Television (TV), a vehicle head unit, a laptop computer, a tablet computer, a Personal Media Player (PMP), and a Personal Digital Assistant (PDA). The electronic device may be configured as a pocket-sized portable communication terminal having wireless communication functionality. Further, the electronic device may be a flexible device or a flexible display device.

The electronic device may communicate with an external electronic device such as a server or may operate in conjunction with an external electronic device. For example, the electronic device may transmit an image captured by a camera and/or location information detected by a sensor unit to the server through a network. The network may be, but not limited to, a mobile or cellular communication network, a Local Area Network (LAN), a Wireless LAN (WLAN), a Wide Area Network (WAN), the Internet, a Small Area Network (SAN), or the like.

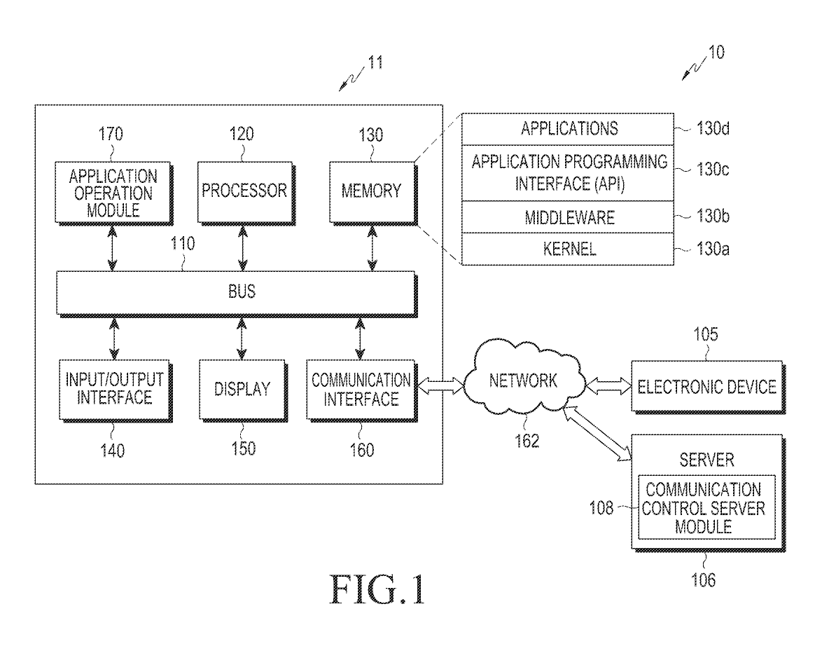

FIG. 1 illustrates a network environment including an electronic device according to various embodiments of the present disclosure.

Referring to FIG. 1, a network environment 10 is illustrated. The network environment 10 may include an electronic device 11. The electronic device 11 may include a bus 110, a processor 120, a memory 130, an Input/Output (I/O) interface 140, a display 150, and a communication interface 160. According to various embodiments of the present disclosure, the electronic device 11 may include an application operation module 170.

The bus 110 may be a circuit that interconnects the foregoing components and allows communication (e.g., a control message and/or data) between the foregoing components.

The processor 120 may include one or more of a Central Processing Unit (CPU), an Application Processor (AP), and a Communication Processor (CP). The processor 120 may, for example, receive instructions from other components (e.g., the memory 130, the I/O interface 140, the display 150, the communication interface 160, or the application operation module 170), interpret the received instructions, and execute computation or data processing according to the interpreted instructions.

The memory 130 may include a volatile memory and/or a non-volatile memory. The memory 130 may, for example, store instructions or data that are received from, or generated by, the processor 120 or other components (e.g., the I/O interface 140, the display 150, the communication interface 160, or the application operation module 170). For example, the memory 130 may include a kernel 130a, middleware 130b, an Application Programming Interface (API) 130c, and/or one or more applications 130d. At least a part of the kernel 130a, the middleware 130b, and the API 130c may be called an Operating System (OS). Each of the foregoing programming modules may include software, firmware, hardware, or a combination of at least two of software, firmware or hardware.

The kernel 130a may control or manage system resources (e.g., the bus 110, the processor 120, or the memory 130) that are used in executing operations or functions implemented in other programming modules such as the middleware 130b, the API 130c, or the application 130d. In addition, the kernel 130a may provide an interface for allowing the middleware 130b, the API 130c, or the application 130d to access individual components of the electronic device 11.

The middleware 130b may be a medium through which the kernel 130a may communicate with the API 130c or the application 130d to transmit and receive data. In addition, the middleware 130b may control work requests received from at least one application 130d (e.g., through scheduling or load balancing) by assigning a priority level for using system resources (the bus 110, the processor 120, or the memory 130) of the electronic device 11 to the at least one application 130d.

The API 130c is an interface through which the application 130d controls functions provided by the kernel 130a or the middleware 130b. For example, the API 130c may include at least one interface or function (e.g., a command) for file control, window control, video processing, or text control.

According to various embodiments of the present disclosure, the application 130d may include a Short Message Service (SMS)/Multimedia Messaging Service (MMS) application, an email application, a calendar application, an alarm application, a health care application (e.g., an application that measures the amount of exercise or a blood sugar level), or an environment information application (e.g., an application that provides information about an air pressure, a humidity level, or a temperature). Alternatively or additionally, the application 130d may be related to information exchange between the electronic device 11 and an external electronic device 105. The information exchange-related application may include, for example, a notification relay application for transmitting specific information to the external electronic device 105 or a device management application for managing the external electronic device 105.

For example, the notification relay application may include a function of transmitting notification information generated from another application (e.g., an SMS/MMS application, an email application, a health care application, or an environment information application) to the external electronic device 105. Alternatively or additionally, the notification relay application may receive notification information from the external electronic device 105 and transmit the received notification information to a user. The device management application may manage (e.g., install, delete, or update) at least a part of functions of the external electronic device 105 communicating with the electronic device 11 (e.g., turn-on/turn-off of the external electronic device (or a part of its components) or control of the brightness (or resolution) of the display), an application executed in the external electronic device 105, or a service (e.g., a call service or a message service) provided by the external electronic device 105.

According to various embodiments of the present disclosure, the application 130d may include an application designated according to a property of the external electronic device 105 (e.g., the type of the electronic device). For example, if the external electronic device 105 is an MP3 player, the application 130d may include an application related to music play. If the external electronic device 105 is a mobile medical device, the application 130d may include an application related to health care. According to an embodiment of the present disclosure, the application 130d may include at least one of an application designated in the electronic device 11 or an application received from another electronic device (e.g., a server 106 or the external electronic device 105).

The I/O interface 140 may serve as, for example, an interface that may receive an instruction or data from a user or another external device and transmit the instruction or data to another component (or other components) of the electronic device 11. In addition, the I/O interface 140 may output a command or data received from another component (or other components) of the electronic device 11 to the user or another external device.

The display 150 may include, for example, a Liquid Crystal Display (LCD), a Light Emitting Diode (LED) display, an Organic LED (OLED) display, a MicroElectroMechanical System (MEMS) display, or an electronic paper display. The display 150 may display, for example, content (e.g., text, an image, a video, an icon, or a symbol) to a user. The display 150 may include a touch screen and may receive, for example, a touch input, a gesture input, a proximity input, or a hovering input using an electronic pen or a body part of a user.

The communication interface 160 may provide communication between the electronic device 11 and another electronic device (e.g., the external electronic device 105 or the server 106). For example, the communication interface 160 may be connected to a network 162 by wireless or wired communication and communicate with the external electronic device 105 over the network 162.

The wireless communication may be conducted in conformance to a cellular communication protocol, for example, one of Long Term Evolution (LTE), LTE-Advanced (LTE-A), Code Division Multiple Access (CDMA), Wideband CDMA (WCDMA), Universal Mobile Telecommunication System (UMTS), Wireless Broadband (WiBro), or Global System for Mobile communications (GSM). The wired communication may be conducted in conformance to at least one of Universal Serial Bus (USB), High Definition Multimedia Interface (HDMI), Recommended Standard 232 (RS-232), or Plain Old Telephone Service (POTS). The network 162 may be a communication network, for example, at least one of a computer network (e.g., LAN or WAN), the Internet, or a telephone network.

According to various embodiments of the present disclosure, the network 162 may be a communication network. The communication network may include at least one of a computer network, the Internet, an Internet of things, or a telephone network. According to various embodiments of the present disclosure, at least one of the application 130d, the API 130c, the middleware 130b, the kernel 130a, or the communication interface 160 may support a protocol (e.g., a transport layer protocol, a data link layer protocol, or a physical layer protocol) for communication between the electronic device 11 and an external electronic device.

According to various embodiments of the present disclosure, the application operation module 170 may support operation of the electronic device 11 by performing at least one of operations (or functions) implemented in the electronic device 11. For example, the server 106 may include a communication control server module 108 that may support the application operation module 170 configured in the electronic device 11. For example, the communication control server module 108 may include at least one of the components of the application operation module 170 and thus perform at least one of the operations of the application operation module 170 (e.g., on behalf of the application operation module 170).

The application operation module 170 may process at least a part of information acquired from other components (e.g., the processor 120, the memory 130, the I/O interface 140, or the communication interface 160) and may use the processed information in various methods. For example, the application operation module 170 may control at least a part of the functions of the electronic device 11 using or independently of the processor 120, so that the electronic device 11 may interact with another electronic device (e.g., the external electronic device 105 or the server 106). The application operation module 170 may be incorporated in the processor 120. According to various embodiments of the present disclosure, at least one component of the application operation module 170 may be included in the server 106 (e.g., the communication control server module 108) and at least one operation performed in the application operation module 170 may be supported by the server 106.

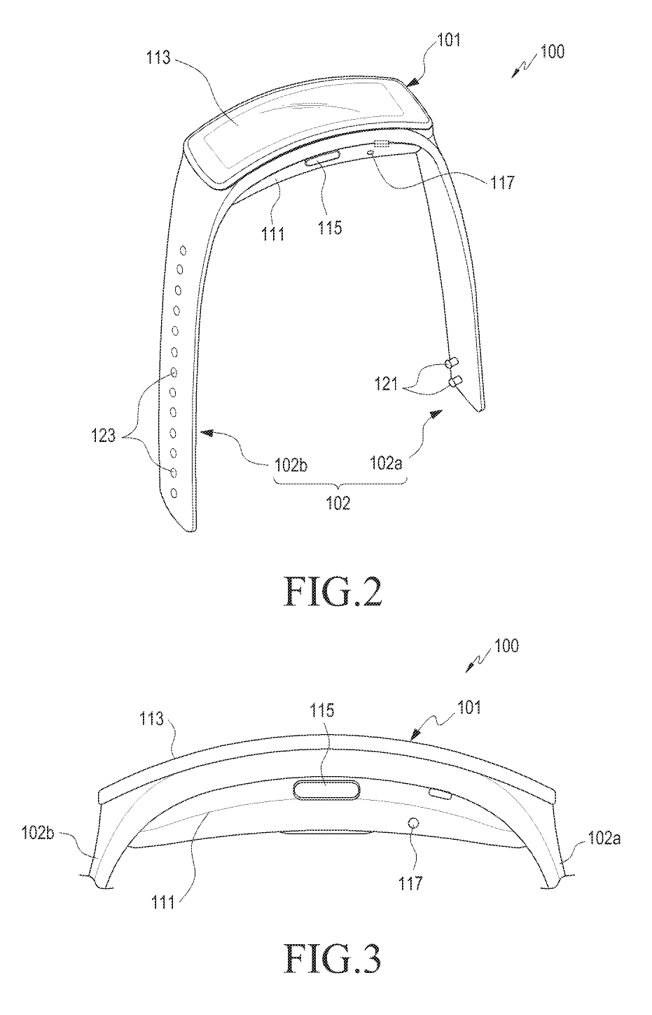

FIG. 2 is a perspective view of an electronic device according to various embodiments of the present disclosure. FIG. 3 is a side view of an electronic device according to various embodiments of the present disclosure.

Referring to FIGS. 2 and 3, the electronic device 100 (e.., the electronic device 11 or the external electronic device 105) according to various embodiments of the present disclosure may include a body 101 and a wearable part 102 extended from the body 101. A user may wear the body 101 on the user's body (e.g., a wrist) using the wearable part 102.

The body 101 may include circuits accommodated in the inner space of a housing 111 and a display 113 mounted on a front surface of the body 101. The display 113 may be integrated with a touch panel, for use as a touch screen. A button-type key 115 and a hole 117 for inputting a sound (hereinafter, referred to as a first sound input hole 117) may be formed on a side surface of the housing 111. The body 101, for example, the housing 111 may be shaped like the body of a general wrist watch. The key 115 and the first sound input hole 117 may be disposed at other appropriate positions in consideration of a body part on which the user wears the electronic device 100.

The wearable part 102 may include a first wearable member 102a extended from one portion of the body 101 and a second wearable member 102b extended from the other portion of the body 101. The first and second wearable members 102a and 102b may be extended from the body 101, receding from each other. According to various embodiments of the present disclosure, the first and second wearable members 102a and 102b may be extended inclined with respect to a direction in which the body 101 is extended, in consideration of the curvature of a body part on which the user wears the body 101.

According to various embodiments of the present disclosure, an end portion of the first wearable member 102a may be engaged at an appropriate position of the second wearable member 102b, to thereby allow the user to wear the body 101 on the user's body. For example, the first wearable member 102a may include at least one engagement protrusion 121 on end portion thereof and the second wearable member 102b may include a plurality of engagement holes 123 arranged in a length direction. With the body 101 contacting the user's body, the engagement protrusion 121 may be engaged in one of the engagement holes 123 so that the wearable part 102 may be kept in a closed curve. Therefore, the user may wear the electronic device 100 stably on the user's body (e.g., a wrist). While not shown, the electronic device 100 may further include a band (or clip) for bringing overlapped parts of the first and second wearable members 102a and 102b into close contact in the closed-curve state.

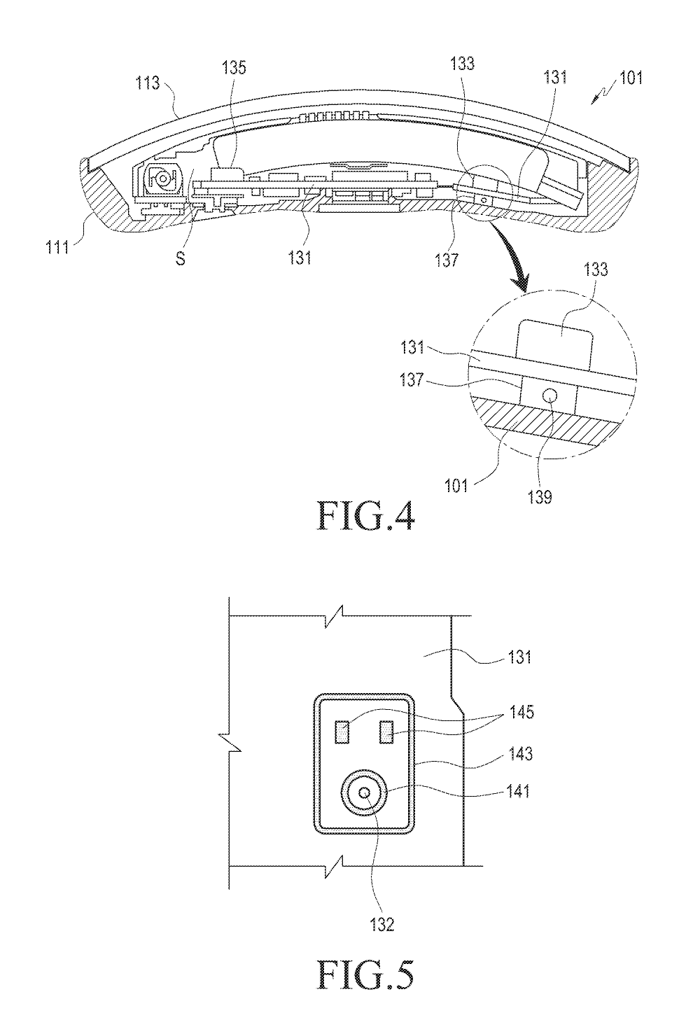

With reference to FIGS. 4, 5, and 6, an interior structure of the electronic device 100 according to various embodiments of the present disclosure will be described below.

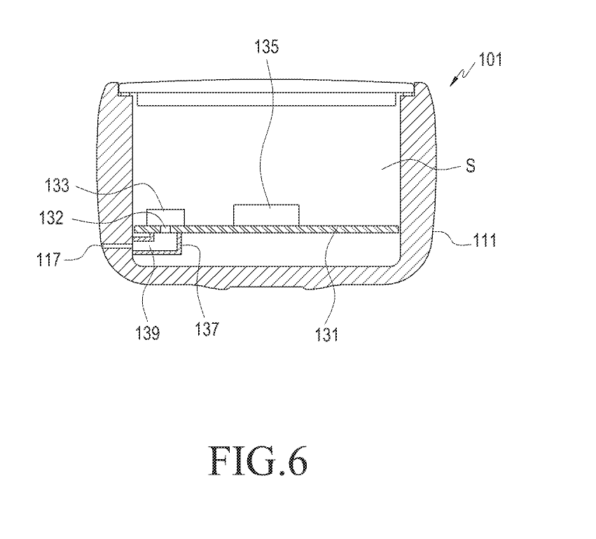

FIG. 4 is a first sectional view of a body of an electronic device according to various embodiments of the present disclosure. FIG. 5 is a plan view of an enlarged part of a circuit board in an electronic device according to various embodiments of the present disclosure. FIG. 6 is a second sectional view of a body in an electronic device according to various embodiments of the present disclosure.

Referring to FIGS. 4, 5, and 6, the circuit board 131 having various electronic parts mounted thereon is accommodated in an inner space of the electronic device 100, for example, the housing 111 and the electronic parts mounted on the circuit board 131 may include a sound module such as a speaker module 135 or a microphone 133. The speaker module 135 and the microphone 133 may be mounted on the circuit board 131 by a surface mounting process. The circuit board 131 may include another sound input hole (132 in FIG. 6) (hereinafter, referred to as a second sound input hole) penetrating through both surfaces of the circuit board 131 in order to provide a sound input path to the microphone 133. The second sound input hole 132 may be disposed in an area in which the microphone 133 is installed.

The speaker module 135 may output a sound to a whole space connected to the speaker module 135. The sound quality of the speaker module 135 may be improved by securing a certain volume of resonant space. If the mounting space of the speaker module 135 is small as in the electronic device 100, the inner space S of the housing 111 may be used as a resonant space. The microphone 133 receives a sound and converts the sound to an electrical signal. A sound output from the speaker module 135 may act as noise input to the microphone 133. For example, the quality of a sound input to the electronic device 100 may be improved by blocking a sound output from the electronic device 100 from being introduced into the microphone 133.

A path in which a sound output from the speaker module 135 may be introduced into the microphone 133 in the inner space S of the housing 111 may be, for example, a space between the microphone 133 and the circuit board 131 and a path running from the first sound input hole 117 to the microphone 133.

As described before, the microphone 133 may be mounted on the circuit board 131 by a surface mounting process. A sealing structure may be formed between the microphone 133 and the circuit board 131 by soldering (e.g., a reflow process in which the microphone 133 is installed by coating solder paste on the circuit board 131 and then heating the solder paste) in the surface mounting process.

Referring to FIG. 5, first and second grounding pads 141 and 143 may be formed on one surface of the circuit board 131. The first grounding pad 141 is shaped into a closed curve (e.g., a circle) surrounding the second sound input hole 132 and the second grounding pad 143 may be shaped like a closed curve or a polygon (e.g., a rectangle) surrounding the first grounding pad 141. For example, the second grounding pad 143 may be shaped in correspondence with one surface of the microphone 133 facing the circuit board 131.

In the surface mounting process, the microphone 133 is mounted on the circuit board 131 by soldering the microphone 133 onto the first and second grounding pads 141 and 143 and the soldering on the first and second grounding pads 141 and 143 may form a double sealing structure to a sound input path (e.g., the path running from the second sound input hole 132 to the microphone 133) between the microphone 133 and the circuit board 131. The first and second grounding pads 141 and 143 may ground the microphone 133. The microphone 133 may be electrically connected to the circuit board 131 through at least one signal terminal 145 formed on the circuit board 131. The at least one signal terminal 145 may be provided in an area between the first and second grounding pads 141 and 143. The at least one signal terminal 145 connected to the microphone 133 may be configured as a pair of a terminal for supplying power and a terminal for transferring a sound signal. The microphone 133 may be connected to the signal terminals 145 by soldering in the surface mounting process.

A guide member 137 may be provided between the first and second sound input holes 117 and 132 in the inner surface S of the housing 111. A sound wave guide 139 may be formed extended from one end to the other end of the guide member 137. The sound wave guide 139 may be linear or bent according to positions of the first and second sound input holes 117 and 132 relative to each other. In an embodiment of the present disclosure, the sound wave guide 139 may be bent at a position near to the second sound input hole 132 as illustrated in FIG. 6.

In the inner space S of the housing 111, as one end and the other end of the guide member 137 are connected to the first sound input hole 117 and the second sound input hole 132 on the other surface of the circuit board 131, respectively, the guide member 137 may complete the sound input path. For example, a user's voice from the outside of the electronic device 100 may sequentially travel through the first sound input hole 117, the sound wave guide 139, and the second sound input hole 132 and reach the microphone 133. This sound input path may be isolated from the other inner space of the housing 111 by the guide member 137 and the sealing structure formed by soldering on the first and second grounding pads 141 and 143. Accordingly, even though the inner space S of the housing 111 is used as a resonant space of the speaker module 135, a sound output from the speaker module 135 may be blocked from being introduced into the microphone 133 in the inner space S of the housing 111.

As is apparent from the foregoing description, when the microphone is mounted on the circuit board by a surface mounting process in the electronic device according to various embodiments of the present disclosure, a double sealing structure can be formed in a sound input path by means of a grounding structure. Therefore, the resonant space of the speaker module is isolated from the sound input path to the microphone in the inner space of the electronic device (e.g., the housing), thereby outputting a good-quality sound from the speaker module and increasing the quality of a sound input to the microphone. Further, because the sound input path is isolated from the resonant space without using an additional shielding structure, the inner space of the electronic device can be used efficiently. The resulting decrease in the number of inner parts or structures can lead to an increase in design freedom in an electronic device having a small mounting space, such as a wearable electronic device.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An electronic device comprising:
a circuit board having a sound input hole penetrating through both surfaces of the circuit board;
a microphone mounted on the circuit board, the microphone configured to receive a sound through the sound input hole;
a first grounding pad surrounding the sound input hole on a surface of the circuit board; and
a second grounding pad surrounding the first grounding pad on the surface of the circuit board,
wherein the microphone is mounted on the circuit board by soldering the microphone to the first and second grounding pads.

2. The electronic device of claim 1, wherein a gap between the microphone and the circuit board is sealed by soldering the microphone to the first and second grounding pads.

3. The electronic device of claim 1, wherein the second grounding pad is shaped in a closed curve or a polygon in correspondence with one surface of the microphone facing the circuit board.

4. The electronic device of claim 1, further comprising:
at least one signal terminal disposed in an area between the first grounding pad and the second grounding pad.

5. The electronic device of claim 1, further comprising:
a housing configured to accommodate the circuit board; and
a second sound input hole formed in the housing,
wherein an external sound input through the second sound input hole travels to the microphone through the sound input hole.

6. The electronic device of claim 5, further comprising:
a guide member disposed on an surface of the circuit board other than the surface on which the microphone is disposed; and
a sound wave guide formed in the guide member,
wherein a path through which sound is input to the microphone is isolated from another space inside the housing by connecting one end of the sound wave guide to the sound input hole on the other surface of the circuit board and by connecting the other end of the sound wave guide to the second sound input hole.

7. The electronic device of claim 6, further comprising:
a speaker module accommodated in the housing,
wherein the other space inside the housing provides a resonant space for the speaker module.

8. An electronic device comprising:
a circuit board having a sound input hole penetrating through the circuit board;
a microphone mounted on the circuit board;
a first grounding pad surrounding the sound input hole on a surface of the circuit board; and
a second grounding pad surrounding the first grounding pad on the surface of the circuit board.
